(19) United States
(12) Patent Application Publication
(10) Pub. No.: US 2006/0236616 A1
(43) Pub. Date: Oct. 26, 2006

(54) Polycrystalline diamond tools and method of making thereof

(76) Inventor: Shan Wan, Lewis Center, OH (US)

Correspondence Address: Pepper Hamilton, 500 Grant Street, 50th Floor, Pittsburgh, PA, 15219, US

(21) Appl. No.: 10/553,644

(22) PCT Filed: May 3, 2004
(86) PCT No.: PCT/US04/13779

§ 371 Date: Oct. 14, 2005

Related U.S. Application Data
(60) Provisional application No. 60/467,311, filed on May 2, 2003.

(51) Int. Cl. C09K 3/14

(52) U.S. Cl. 51/309

(57) ABSTRACT

The present invention is a tool insert. The tool insert includes a abrasive layer and a substrate. The abrasive layer has a periphery forming a cutting surface and is located on the substrate. The abrasive layer includes at least one of polycrystalline diamond or cubic boron nitride. The abrasive layer tool insert has a sum value of an impact resistance number and an abrasion resistance number that is ≧19,000. The impact resistance number is equal to a total number of hits before failure of the tool insert. The abrasion resistance number is equal to equation (1) (1) abrasion resistance=final volume of granite removed by the tool insert (inch³)/final tool wear land area (inch²).

### CROSS REFERENCE OF RELATED APPLICATIONS

This application claims the benefit of U.S. Provisional Patent Application No. 60/467,311 filed May 2, 2003, which is hereby incorporated by reference in its entirety.

### BACKGROUND

1. Field of the Invention

The present invention generally relates to polycrystalline diamond tools and method of manufacturing thereof. More particularly, the present invention relates to polycrystalline diamond tools having increased impact and abrasion resistance properties.

2. Description of Related Art

Polycrystalline diamond (“PCD”) tools are used extensively in drilling, cutting, and machining applications. Extensive efforts have been made to improve the abrasion resistance and impact resistance properties. Large diamond grain size leads to high impact resistance but relatively low abrasion resistance for drilling cutters. Alternatively, fine diamond grain size is utilized for increased abrasion resistance which leads to decreased impact resistance.

It has been a challenge to achieve both high impact resistance and abrasion resistance for polycrystalline diamond tools. The effect of grain size dependence on the performance of polycrystalline diamond drilling cutters has been extensively investigated. Different from normal ceramics such as alumina and silicon carbide, whose fracture toughness increases with decreasing grain size, fracture toughness of PCD, which determines the impact resistance of the cutter, actually decreases with finer diamond. grain size as disclosed in Miess, D. and Rai, G., Fracture Toughness and Thermal Resistance of PDC, Materials Science and Engineering, A29,270-276, 1996.

Therefore, to avoid severe diamond table failure such as delamination and spalling in high impact drilling applications, a coarse grain size microstructure is desired. However, with the larger grain size, abrasion resistance is sacrificed, thereby limiting the lifetime of the cutter due to the fast wear of the diamond table. Various attempts have been made to address this concern by varying the diamond table configuration. For example, U.S. Pat. No. 4,311,490 describes a non-uniform diamond table configuration including an upper fine grain layer and a lower coarse grain layer. U.S. Pat. No. 4,604,106 proposes a PCD compact comprising a transition layer with a diamond-carbide composite between a normal carbide substrate and a working PCD layer. Another example is EP Patent Application No. 1190791 which describes a non-uniform microstructure with gradient distribution of catalyzing materials. With these non-uniform microstructures, the fracture toughness of the portion of diamond table close to supporting substrates can be improved. Consequently, the top portion of diamond table remains brittle and has a tendency to fail under high impact.

U.S. Pat. No. 5,766,394 describes some examples made with a particle size distribution including three different average particle sizes, with the particle size distribution showing a continuous size variation. U.S. Pat. No. 6,261,329 proposes a diamond sintered body consisting of particles with sizes ranging from 0.1 micron to 70 microns, having continuous particle size distribution. U.S. Patent Application No. 20040062928 proposes a machining tool made of a bimodal powder mixture and a certain amount of binder-catalyst. U.S. Pat. Nos. 5,468,268 and 5,505,748 describe a tri-modal powder mixture to make a PCD compact. Based on the example provided by U.S. Pat. No. 5,505,748, the calculated relative density of packing body will be between 0.66-0.72 using the extended Westman model (See Westman, A. E. R., and Hugill, H. R., The Packing of particles, J. Am. Ceram. Soc., 13[10], 767-769, 1930). U.S. Pat. No. 5,855,996 describes a mixture of an average size with submicron sized diamond particles and large sized particles.

Accordingly, a need exists for tools or tool inserts that provide combined increased impact and abrasion resistance, including the manufacturing of an optimum powder mixture with shape and volume fraction controlled fine particles and coarse particles, that overcomes the disadvantages of the single size diamond grain microstructure and improves the overall performance of the tools with respect to combined abrasion resistance and impact resistance properties.

### SUMMARY

The present invention relates to cutting elements, comprising sintered polycrystalline diamond or cubic boron nitride (cBN) starting from a feed of bimodal powder mixture of two different types of single size particles. The cutting elements or tool inserts may be utilized in drilling, machining, milling or cutting applications and the like. The invention further relates to improving the impact resistance and/or abrasion resistance of cutting elements by the use of PCD or cubic boron nitride starting from a bimodal powder mixture of two different types of single size or substantially uniform particles.

An embodiment of the present invention is directed to a tool insert. The tool insert includes a abrasive layer and a substrate. The abrasive layer has a periphery forming a cutting surface and is located on the substrate. The abrasive layer includes at least one of polycrystalline diamond or cubic boron nitride. The abrasive layer tool insert has a sum value of an impact resistance number and an abrasion resistance number that is ≧19,000. The impact resistance number is equal to a total number of hits before failure of the tool insert. The abrasion resistance number is equal to equation (1)

$$abrasion resistance = \frac{\begin{matrix}final volume of granite removed \\ by the tool insert ( {inch}^{3} )\end{matrix}}{final tool wear land area ( {inch}^{2} ) .} \qquad ( 1 )$$

Test methods for abrasion and impact resistance are described in the examples hereinbelow.

The abrasive layer may be sintered with a high pressure high temperature process. Additionally the abrasive layer is formed from a bimodal powder mixture having at least one of polycrystalline diamond or cubic boron nitride. The bimodal powder mixture includes fine particles of a substantially uniform size and coarse particles of a substantially uniform size. The coarse particles have a different substantially uniform size than the substantially uniform size of the fine particles. An average size ratio of fine particles over coarse particles is between about 0.02 and 0.75, preferably between about 0.05 and 0.5, and more preferably between about 0.1 and 0.5. A standard deviation of particle size distribution of fine particles and coarse particles may be smaller than about 0.6 d, preferably 0.5 d, and more preferably 0.4 d, where d is an average particle size. Abrasive crystals of the continuous abrasive layer may have an average aspect ratio of particles of greater than about 0.3, preferably greater than about 0.4, and more preferably greater than about 0.5. A volume fraction of fine particles may be between about 5% to 90%, preferably about 10% to 80%, and more preferably about 15% to 70%. A volume fraction of coarse particles may be between about 10% to 95%, preferably about 20% to 90%, and more preferably about 30% to 85%. The abrasive layer may have at least 93 vol. % of diamond.

The present invention is also directed to a method for manufacturing a tool insert component. In an embodiment, the method includes forming an abrasive layer with a bimodal powder and sintering the abrasive layer with a high pressure high temperature process. The bimodal powder includes at least one of polycrystalline diamond and cubic boron nitride. The bimodal powder includes fine particles of a substantially uniform size and coarse particles of a substantially uniform size. The coarse particles have a different substantially uniform size than the fine particles of substantially uniform size. Abrasive crystals of the abrasive layer may have an average aspect ratio of particles greater than about 0.3. The method may also include the step of bonding a substrate to the abrasive layer.

The abrasive layer in the method has abrasion resistance and impact resistance properties. A sum value of an impact resistance number and an abrasion resistance number is ≧19,000. The impact resistance number is equal to a total number of hits before failure of the tool insert component. The abrasion resistance number is equal to equation (1)

$$abrasion resistance = \frac{\begin{matrix}final volume of granite removed \\ by the tool insert ( {inch}^{3} )\end{matrix}}{final tool wear land area ( {inch}^{2} ) .} \qquad ( 1 )$$

A volume fraction of fine particles may be between about 5% to 90%, and a volume fraction of coarse particles may be between about 10% to 95%. An average size ratio of fine particles over coarse particles may be about 0.02-0.75.

Another embodiment of the present invention is directed to a tool insert having increased abrasion resistance and impact resistance properties. The tool insert includes an abrasive layer and a substrate. The abrasive layer is formed from a bimodal powder mixture comprising fine particles of a substantially uniform size and coarse particles of a substantially uniform size. Abrasive crystals of the abrasive layer have an average aspect ratio of particles greater than about 0.3.

### BRIEF DESCRIPTION OF THE DRAWINGS

FIG. 1 is a graph illustrating packing density as a function of measured particle aspect ratio for single size diamond particles.

FIG. 2 is a graph illustrating calculated packing densities as a function of fine particle volume fraction with various particle size ratio r for bimodal diamond particles.

FIG. 3 is a graph illustrating bimodal powder packing densities as a function of fine particle volume fraction with a particle size ratio of 0.22 and various aspect ratios.

FIG. 4 is a graph illustrating particle size distribution of a bimodal powder mixture used in one embodiment of the present invention, cutter C.

FIG. 5 is a graph illustrating the performance between the bimodal feed cutter of one embodiment of the present invention and prior art mono-modal feed cutters.

FIG. 6 is a graph illustrating diamond vol% in sintered PCD with mono-modal powder and bimodal powder.

### DETAILED DESCRIPTION

The present invention generally relates to tools and/or cutting elements for machine wear materials, such as rotary drill bits for use in drilling or coring holes. The present invention may be applied to a number of different kinds of drill bits, including drag bits, roller cone bits and percussion bits. The tools and/or cutting elements of the present invention may also be used in machining, milling, cutting applications and the like.

By way of example, the present invention will be primarily described in relation to a cutting element which includes a preform element, often in the form of a circular tablet, including a cutting table or abrasive layer of superhard material having a front cutting face, a peripheral surface, and a rear face. The abrasive layer may be continuous. The rear face of the cutting table may be bonded to a substrate of material which is less hard than the superhard material.

The cutting table may include polycrystalline diamond crystals, although other hard or superhard materials for example, cubic boron nitride or combinations thereof may be utilized. The substrate of less hard material may be formed from cemented tungsten carbide, or the like. The cutting table and substrate are then bonded together during formation of the cutting element in a high pressure high temperature (“HPHT”) forming press for example, as known in the art. The preform cutting element may be directly mounted on the bit body or may be bonded to a carrier disc, for example also of cemented tungsten carbide, the carrier disc being in turn received in a socket in the bit body. The bit body may be machined from metal, usually steel, or may be formed from an infiltrated tungsten carbide matrix by a powder metallurgy process.

In one embodiment, the substrate may be formed by joining together two or more disparate carbide discs in the HPHT sintering process to form the PDC cutter. The carbide discs may vary from each other in binder content, carbide grain size, or carbide alloy content. In another embodiment, the carbide discs may be selected and arranged to produce a gradient of materials content in the substrate which modifies and provides the properties for the cutting table.

The diamond clusters forming the cutting table are produced by a method which provides a source of carbon and a plurality of growth center particles, each growth center particle comprising a bonded mass of constituent particles, producing a reaction mass by bringing the carbon source and the growth center particles into contact with a solvent/catalyst, subjecting the reaction mass to conditions of elevated temperature and pressure suitable for crystal growth and recovering a plurality of the diamond clusters, as discrete entities, from the reaction mass. The carbon source may be graphite, HPHT synthetic diamond, chemical vapor deposited (CVD) diamond or natural diamond, or a combination of two or more thereof or other carbon sources known in the art. Diamond crystals are commercially available from a number of suppliers including, for example, Diamond Innovations, Inc. of Worthington, Ohio.

In the HPHT sintering process, the grain size of PCD is mainly determined by the initial or starting diamond particle size. Therefore, by controlling the starting particle size, it is possible to control the final microstructure. The impact strength of the PCD body is greatly dependent on the diamond-to-diamond bonding. A high extent of diamond-to-diamond bonding is preferred to achieve better performance. This can be accomplished by increasing the starting powder packing density. Theoretically, the highest relative density of a single size sphere packing body is 0.74, and the highest relative density of bimodal powder packing body, which contains two types of single size particles, is 0.93. Particle shape also affects the packing of the green body. Irregular particle shape usually leads to lower packing density than that of perfect spheres.

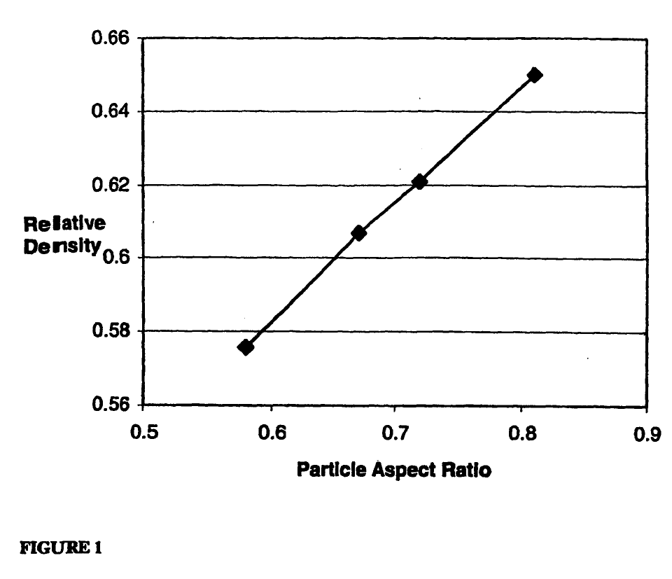

The dependence of relative density of a diamond powder packing body on particle shape is determined experimentally. As shown in FIG. 1, for single size diamond particles, a particle aspect ratio near 1.0 leads to higher packing density. Aspect ratio is defined as a ratio of the minimum Feret diameter to the maximum Feret diameter of a particle, where a Feret diameter is the mean value of the distance between pairs of parallel tangents to the projected outline of the particle. Therefore, blocky particles with an aspect ratio close to 1.0 are preferable to achieve high green body packing density.

The diamond crystals in the present invention have relatively large aspect ratios. In one embodiment of the invention, the diamond crystals may have largely well defined cubo-octahedral shapes. In a second embodiment, the crystals may have a large aspect ratio in various shapes, including ellipsoidal. In a third embodiment, the crystals may be essentially two dimensional such as laminas and/or flakes. In yet another embodiment, the crystals may be essentially one dimensional, for example, rod-like, fiber-like and/or needle-like.

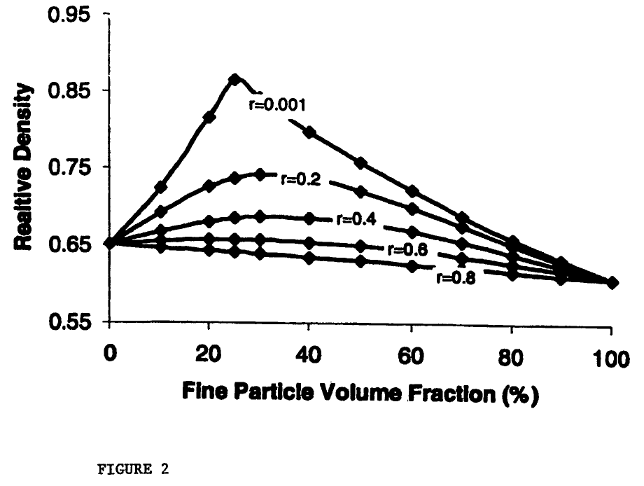

The Westman packing model specifically for diamond powder mixture is developed based on the initial single size or substantially uniform particle packing densities. It shows that high green body packing density can be obtained by uniformly mixing two types of particles with controlled particle size and shape distribution. FIG. 2 shows the relative density of a diamond powder packing body calculated from the packing model as a function of volume fraction of two different size particles or bimodal powder and their particle size ratio r, where r=fine particle size/coarse particle size.

As shown in FIG. 2, the bimodal powder mixture packing density is mainly dependent on the following factors: initial packing density for each single size particles, which is determined by the particle shape, particle size ratio between two different size particles, and volume fraction of each single size powder. FIG. 2 illustrates that a lower particle size ratio leads to a higher packing density, thereby meaning that a greater size difference is preferred for achieving closer packing. On the other hand, the volume fraction greatly affects the packing density. It can be seen that for a fixed particle size ratio, a bimodal powder mixture with around 70% coarse particles and around 30% fine particles has the highest packing density. With higher green body packing density, the powders are crushed less under a HTHP process which in turn contributes to higher impact resistance.

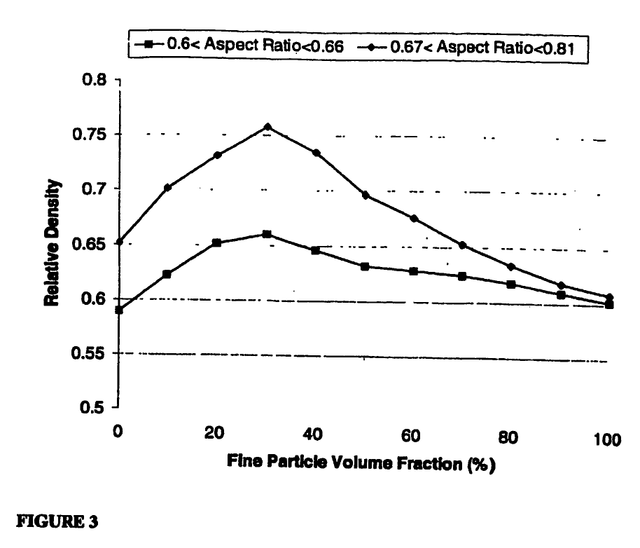

FIG. 3 illustrates that for a bimodal powder mixture, packing density is highly dependent on the volume ratio and the aspect ratio of the particle components, assuming the same particle size ratio. The blockier particles with aspect ratio close to 1.0 pack better than the more irregular shaped particles with smaller aspect ratios. The high packing density, which is achieved from the particle size ratios, mix ratios and shapes as leads to better tool performance, including impact resistance and abrasion resistance.

The following tests are described to illustrate the impact resistance and abrasion resistance properties of exemplary embodiments of cutting tools of the present invention and comparative prior art samples.

Abrasion Resistance Test: Each sample has a carbide chamfer of greater than about 0.2 mm, less than 1.0 mm radial or 45° on the locating base. First, a Barre ray granite log (dimension: φ8-12 inches×L 24 inches, vendor: Rock Of Ages) is fitted to a lathe. The cutter with unchamfered sharp edge is mounted into a steel support. The test area of the cutter preferably has a planar area no greater than 2×10⁻⁵ inch² prior to testing. The cutter (rake angle: 15 degrees) runs across the rotating log with cooling water sprayed to the cutting area. The size of the wear on the cutter is measured by 12× microscope perpendicular to the wear land after each pass of the log. Therefore the measured area is a true plane area, not an area projected from an angle other than 90 degrees from the wear plane. The volume of material removed from the log is measured. The values are plotted against each other giving the abrasion resistance of the cutter. The abrasion resistance is calculated as final volume (inch³) of the granite removed by the tool divided by the final wear land area (inch²).

Interrupted Mill Test: This test is to estimate the impact performance of the cutter on a chamfered sample, with each piece having a carbide chamfer of greater than about 0.2 mm, less than 1.0 mm radial or 45° on the locating base. The diamond table has a 0.012 inch chamfer by 45°. In this test, the cutter (chamfered edge) sample is mounted in a steel holder. The cutter is rotated and cuts in an interrupted fashion and transverse distance of 0.15 inch through a Wausau granite work piece, (the cutting plane area of the block is about 16 inches long×6.375 inches high, vendor: Cold Spring Granite). No cooling liquid is used during the test. The test is stopped when the diamond table fails, typically when the worn cutting area reaches the interface between the diamond table and the substrate and the number of impacts (entries into the log) counted. This is determined optically with 1×.

It has been determined that the abrasive layer of a tool insert or the like demonstrates increased impact resistance and abrasion resistance when the following defined relationship is satisfied:
impact resistance number+abrasion resistance number≧19,000
Preferably, the sum value of the impact resistance number and the abrasion resistance number ≧20,000. The impact resistance number is the total number of impact hits before tool failure. The abrasion resistance number is calculated as the final volume (inch³) of the granite removed by the tool divided by the final wear land area (inch²). As discussed hereinabove, such properties are achieved by the bimodal powder having fine particles of a uniform size and coarse particles of uniforms size, with the fine particles and coarse particles varying in shape to yield high diamond phase density. This will be further demonstrated with the following examples.

### EXAMPLE

The examples below are merely representative of the work that contributes to the teachings of the present invention, and the present invention is not to be restricted by the examples that follow.

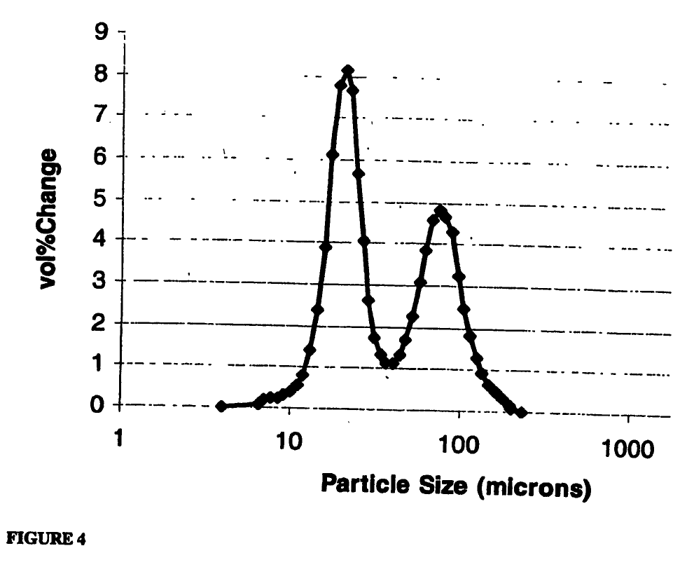

In the examples, two types of PCD diamond particles commercially available from Diamond Innovation of Worthington, OH, having particles with an average particle size of about 85 micron and about 20 micron are mixed uniformly. The experimental packing density of the powder mixture is illustrated in FIG. 3. It can be seen that the shape-optimized bimodal powders can increase the packing density by up to 20% compared to a single particle size or substantially uniform powder. The particle size distribution of a typical bimodal powder mixture is shown in FIG. 4. The tool is sintered by normal HTHP process.

The abrasion resistance of the tool is measured by granite-log wear test as described above. The test sample has a cylinder shape with a diameter of 13 mm and a height of 13 mm. The diamond table thickness is 2.5 mm. The cutting edge of test part is initially sharp without chamfering. Test is performed on an 8-12 inches diameter granite-log installed on a lathe. The rotation speed of granite log is controlled with constant surface moving speed: 300 SFPM (Surface Feet Per Minute). The cutting tool has 15 degrees of rake angle and moves parallel to the center-line of the log with cooling water sprayed to the cutting area. Cutting depth of the tool into the granite log is 0.01 inch. The cross-feed is 1.5 inch/min. The wear land area is measured every 2 minutes and the test stopped after 18 minutes. The abrasion resistance is calculated as final volume (inch³) of the granite removed by the tool divided by the final wear land area (inch²).

The impact resistance is characterized by interrupting impact test performed on Interrupted Mill test machine as described above. Samples have the same geometry as those for abrasion test, with the exception of the chamfer. Each sample has a 0.012 inch, 45 degrees circumferential chamfer on the test edge. The sample is held by a tool holder spinning at 320 RPM. The tool cuts into a granite block with a depth of 0.15 inch and 15 degrees rake angle. Each granite block is 16 inches long and moves along the cutting plane with a speed of 2.1 inch/min. A pass is complete when the tool has cleared the block. After each pass, the granite block is moved back to the starting point and moved toward the cutting tool to establish a new 0.15 inch cutting depth. The impact resistance is then measured by the number of the times the tool engages or “hits” the granite block before the tool fails. Tool failure is defined by when the diamond table has been worn to the point that the tungsten carbide substrate is exposed. For this described test, each pass or “hit” represents an impact resistance of 2080. For example, if the tool engages the block five (5) times prior to failure, impact resistance is determined to be (5×2080), 10,400.

With the shape, particle size ratio, and volume fraction optimized bimodal powder mixture, the performance of the PCD cutting tool is highly improved as demonstrated. The impact resistance number in Table 1 represents the overall hit number on the cutter before the cutter loses cutting efficiency and fails. The abrasion resistance number in Table 1 represents the tool efficiency defined as the ratio of the removed granite materials volume over the wear land area of the cutter. Higher tool efficiency means better abrasion resistance.

Cutter A and B represent comparable/standard cutters made of traditional single size or substantially uniform particles commercially available from various sources, including Diamond Innovations of Worthington, Ohio. A is made of coarse particles with an average size of 85 micron and an average particle aspect ratio of 0.81. B is made of fine particles with an average particle size of 20 micron and an average particle aspect ratio of 0.67. The particle size distributions for both powders were controlled so that the standard deviations of particle size distributions are less than 0.3 d, where d is average particle size. Cutter C is made from the bimodal feeds of the present invention by mixing the substantially uniform coarse particles used in Cutter A and the substantially uniform fine particles used in cutter B.

Table 1 shows the impact resistance and abrasion resistance of three different cutters. As shown in Table 1, compared to standard single coarse particle size cutter A, cutter C with bimodal particles maintains high impact resistance and has three times higher abrasion resistance. Compared to standard single fine particle size cutter B, cutter C with optimized bimodal particles has 50% higher impact resistance and 20% higher abrasion resistance.

TABLE 1
Summary of impact resistance and abrasion resistance of cutters A, B and C.

| | Coarse | Fine | Particle | Particle | Impact | Abrasion |
|---|---|---|---|---|---|---|
| | Particle vol % | Particle vol % | Size Ratio | Aspect Ratio | Resistance | Resistance |
| A: Standard Cutter with | 100% | 0 | — | 0.81 | 15029 | 2731 |
| uniform coarse size particle | | | | | | |
| B: Standard Cutter with | 0 | 100% | — | 0.67 | 10500 | 7500 |
| uniform fine size particle | | | | | | |
| C: Optimized Bimodal | 40% | 60% | 0.22 | Average | 15600 | 10048 |
| Cutter Example 1 | | | | 0.73 | | |

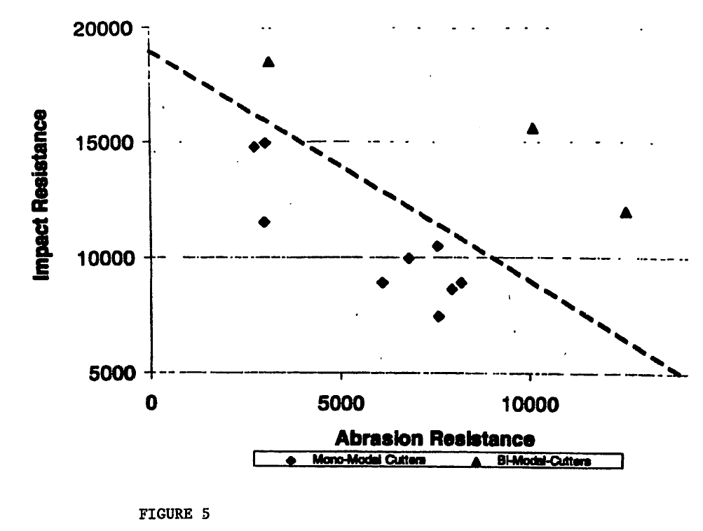

FIG. 5 illustrates impact resistance v. abrasion resistance for bimodal cutters and mono-modal cutters. The dashed line of FIG. 5 represents the sum value of the impact resistance number on the y-axis and the abrasion resistance number on the x-axis being equal to 19,000. The mono-modal cutters typically utilized in industry and prior art have an impact resistance number+abrasion resistance number sum below 19,000 or to the left of the dashed line. The high performance bimodal cutters have values to the right of the dashed line, thereby demonstrating impact resistance number +abrasion resistance number ≧19,000, preferably ≧20,000 and thereby demonstrating the desired properties.

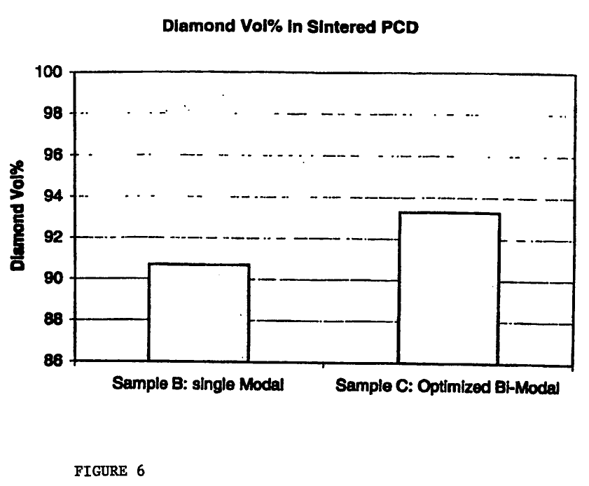

Additionally, FIG. 6 illustrates a diamond vol. % of cutter B, starting from the single modal powder and cutter C, starting from the bimodal powder in a sintered state. The diamond volume fraction is calculated by comparing the measured density of the sinter PCD to the single crystal diamond density. In particular, FIG. 6 illustrates the diamond volume percentage in the final sintered PCD tool starting from different diamond powder. Cutter C having the bimodal powder demonstrates a higher diamond volume fraction 93.3%. Conversely, cutter B, with the single modal powder demonstrates a lower diamond content 90.6%.

In another embodiment, the present invention is directed to a method for manufacturing a tool insert component. The method includes forming an abrasive layer with a bimodal powder and sintering said abrasive layer with a high pressure high temperature process. The bimodal powder includes at least one of polycrystalline diamond and cubic boron nitride. The bimodal powder includes fine particles of a substantially uniform size and coarse particles of a substantially uniform size. The coarse particles have a different substantially uniform size than the fine particles of substantially uniform size. Abrasive crystals of the abrasive layer may have an average aspect ratio of particles greater than about 0.3. The method may also include the step of bonding a substrate to the abrasive layer.

The abrasive layer in the method has abrasion resistance and impact resistance properties. A sum value of an impact resistance number and an abrasion resistance number is ≧19,000. The impact resistance number is equal to a total number of hits before failure of the tool insert component. The abrasion resistance number is equal to equation (1)

$$abrasion resistance = \frac{\begin{matrix}final volume of granite removed \\ by the tool insert ( {inch}^{3} )\end{matrix}}{final tool wear land area ( {inch}^{2} ) .} \qquad ( 1 )$$

A volume fraction of fine particles may be between about 5% to 90%, and a volume fraction of coarse particles may be between about 10% to 95%. An average size ratio of fine particles over coarse particles may be about 0.02-0.75.

In yet another embodiment, the present invention is directed to a tool insert having increased abrasion resistance and impact resistance properties. The tool insert includes an abrasive layer and a substrate. The abrasive layer is formed from a bimodal powder mixture comprising fine particles of a substantially uniform size and coarse particles of a substantially uniform size. Abrasive crystals of the abrasive layer have an average aspect ratio of particles greater than about 0.3.

While the present invention is satisfied by embodiments in many different forms, there is shown in the drawings and described herein in detail, the preferred embodiments of the invention, with the understanding that the present disclosure is to be considered as exemplary of the principles of the invention and is not intended to limit the invention to the embodiments illustrated. Various other embodiments will be apparent to and readily made by those skilled in the art without departing from the scope and spirit of the invention. The scope of the invention will be measured by the appended claims and their equivalents.

What is claimed is:

1. A tool insert comprising:
a abrasive layer having a periphery forming a cutting surface wherein said continuous abrasive layer comprises at least one of polycrystalline diamond or cubic boron nitride; and
a substrate, said abrasive layer being located on said substrate, wherein said abrasive layer tool insert has a sum value of an impact resistance number and an abrasion resistance number ≧19,000, wherein the impact resistance number is equal to a total number of hits before failure of the tool insert and the abrasion resistance number is equal to equation (1)
$$abrasion resistance = \frac{\begin{matrix}final volume of granite removed \\ by the tool insert ( {inch}^{3} )\end{matrix}}{final tool wear land area ( {inch}^{2} ) .} \qquad ( 1 )$$

2. The tool insert of claim 1, wherein said abrasive layer is sintered with a high pressure high temperature process.

3. The tool insert of claim 1, wherein said abrasive layer is formed from a bimodal powder mixture having at least one of the polycrystalline diamond or cubic boron nitride.

4. The tool insert of claim 3, wherein the bimodal powder mixture comprises fine particles of a substantially uniform size and coarse particles of a substantially uniform size, said coarse particles having a different substantially uniform size than the substantially uniform size of the fine particles.

5. The tool insert of claim 4, wherein an average size ratio of fine particles over coarse particles is between about 0.02 and about 0.75.

6. The tool insert of claim 4, wherein an average size ratio of fine particles over coarse particles is between about 0.05 and about 0.5.

7. The tool insert of claim 4, wherein an average size ratio of fine particles over coarse particles is between about 0.1 and about 0.5.

8. The tool insert of claim 4, wherein a standard deviation of particle size distribution of fine particles and coarse particles is smaller than about 0.6 d, where d is an average particle size.

9. The tool insert of claim 4, wherein abrasive crystals of said abrasive layer have an average aspect ratio of particles of greater than about 0.3.

10. The tool insert of claim 4, wherein abrasive crystals of said abrasive layer have an average aspect ratio of particles of greater than about 0.4.

11. The tool insert of claim 4, wherein abrasive crystals of said abrasive layer have an average aspect ratio of particles of greater than about 0.5.

12. The tool insert of claim 4, wherein a volume fraction of fine particles is between about 5% to 90%, and a volume fraction of coarse particles is between about 10% to about 95%.

13. The tool insert of claim 4, wherein a volume fraction of fine particles is between about 10% to 80%, and a volume fraction of coarse particles is between about 20% and about 90%.

14. The tool insert of claim 4, wherein a volume fraction of fine particles is between about 15% to 70%, and a volume fraction of coarse particles is between about 30% and about 85%.

15. The tool insert of claim 3, wherein said abrasive layer has at least about 93 vol. % of diamond.

16. A method for manufacturing a tool insert component comprising:
forming an abrasive layer with a bimodal powder comprising at least one of polycrystalline diamond and cubic boron nitride, said bimodal powder comprising fine particles of a substantially uniform size and coarse particles of a substantially uniform size, said coarse particles having a different substantially uniform size than the fine particles of substantially uniform size, wherein abrasive crystals of said abrasive layer have an average aspect ratio of particles greater than about 0.3; and
sintering said abrasive layer with a high pressure high temperature process.

17. The method according to claim 16, further comprising the step of bonding a substrate to said abrasive layer.

18. The method according to claim 16, wherein said abrasive layer having abrasion resistance and impact resistance properties, has a sum value of an impact resistance number and an abrasion resistance number ≧19,000, wherein the impact resistance number is equal to a total number of hits before failure of the tool insert and the abrasion resistance number is equal to equation (1)
$$abrasion resistance = \frac{\begin{matrix}final volume of granite removed \\ by the tool insert ( {inch}^{3} )\end{matrix}}{final tool wear land area ( {inch}^{2} ) .} \qquad ( 1 )$$

19. The method of claim 16, wherein a volume fraction of fine particles is between about 5% to 90%, and a volume fraction of coarse particles is between about 10% and about 95%.

20. The method of claim 16, wherein an average size ratio of fine particles over coarse particles is about 0.02 to about 0.75.

21. A tool insert having increased abrasion resistance and impact resistance properties, comprising an abrasive layer and a substrate, wherein said abrasive layer is formed from a bimodal powder mixture comprising fine particles of a substantially uniform size and coarse particles of a substantially uniform size, wherein abrasive crystals of the abrasive layer have an average aspect ratio of particles greater than about 0.3.
